(19) United States
(12) Patent Application Publication
(10) Pub. No.: US 2026/0265472 A1
(43) Pub. Date: Sep. 10, 2026

(54) STRETCHED FILM

(71) Applicant: KANEKA CORPORATION, Osaka (JP)

(72) Inventors: Naoya Kamikariya, Osaka (JP); Fuminobu Kitayama, Osaka (JP); Masahide Shinobu, Osaka (JP); Arihiro Saito, Osaka (JP)

(73) Assignee: KANEKA CORPORATION, Osaka (JP)

(21) Appl. No.: 19/545,462

(22) Filed: Feb. 20, 2026

(30) Foreign Application Priority Data
Mar. 7, 2025 (JP) 2025-036077

(51) Int. Cl. C08J 5/18; B32B 27/08; B32B 38/00; C08K 5/053; C08K 5/20

(52) U.S. Cl. CPC C08J 5/18; B32B 27/08; B32B 38/0004; B32B 38/0012; C08K 5/053; C08K 5/20; B32B 2038/0028; B32B 2250/03; B32B 2250/40; B32B 2255/10; B32B 2255/26; B32B 2307/518; B32B 2355/00; B32B 2367/00; B32B 2439/46; B32B 2439/70; C08J 2331/02; C08J 2431/02

(57) ABSTRACT

A stretched film contains a resin component containing a poly(3-hydroxyalkanoate) resin (A) and a polylactic acid resin (B). The poly(3-hydroxyalkanoate) resin (A) contains a copolymer (A1) of 3-hydroxybutyrate units and other hydroxyalkanoate units, and a poly(3-hydroxybutyrate) resin (A2). In the stretched film, the proportion of the resin component is more than 99.6 wt %, and the inequality (Ma÷10⁴)×Wb≥1600 is satisfied, where Ma is the weight-average molecular weight of the totality of the poly(3-hydroxyalkanoate) resin (A), and Wb is the percentage weight proportion of the polylactic acid resin (B) with respect to the total amount of the poly(3-hydroxyalkanoate) resin (A) and the polylactic acid resin (B).

### FIELD OF THE INVENTION

One or more embodiments of the present invention relate to a stretched film containing a poly(3-hydroxyalkanoate) resin.

### BACKGROUND

Separate collection and composting of raw garbage have recently been promoted, especially in Europe, and there is a demand for plastic products that are compostable together with raw garbage. In addition, plastics with marine degradability are regarded as promising materials to address plastic-induced marine pollution.

Poly(3-hydroxyalkanoate) resins, typified by poly(3-hydroxybutyrate-co-3-hydroxyhexanoate), have drawn attention as plastic materials having compostability and marine degradability.

Investigations have been conducted into forming various types of molded articles from these poly(3-hydroxyalkanoate) resins. Examples of such molded articles include resin films.

One known approach to enhancing the strength of a resin film is to stretch the film.

Although poly(3-hydroxyalkanoate) resins are biodegradable, they have poor processability. In addition, a film formed from such a resin undergoes a significant dimensional shrinkage upon heating. Chinese Patent Application Publication No. 116178915 addresses these and teaches forming a film from a blend of a poly(3-hydroxyalkanoate) resin with another biodegradable resin such as polylactic acid that has a glass transition temperature of 20° C. or higher. The literature states that, as a result, a stretched film having a low thermal shrinkage percentage and having high transparency can be obtained.

Poly(3-hydroxyalkanoate) resins crystallize slowly as compared with other common thermoplastic resins, and require a relatively long time to solidify after being melted by heating. Accordingly, film molding using a poly(3-hydroxyalkanoate) resin tends to exhibit low productivity.

Furthermore, poly(3-hydroxyalkanoate) resins have poor stretchability, and a film molded from a poly(3-hydroxyalkanoate) resin tends to be difficult to stretch at a high stretch ratio.

Packaging is an example of applications of resin films. When a resin film is used for packaging purposes, the resin film may be required to have high transparency so that the packaged product can be visually recognized through the resin film. However, stretching a poly(3-hydroxyalkanoate) resin-containing film generally tends to increase the roughness of the film surface, thereby deteriorating the haze (in particular, external haze) of the film.

Furthermore, a resin film may be required to exhibit good printability to allow printing on its surface.

### SUMMARY

In view of the above circumstances, one or more embodiments of the present invention aim to provide a poly(3-hydroxyalkanoate) resin-containing stretched film that can be produced with good productivity and good stretchability and that exhibits both low haze and good printability.

As a result of intensive studies with the goal of addressing the above, the present inventors have found that a stretched film having the above-described desired properties can be formed when the following requirements are satisfied: a poly(3-hydroxyalkanoate) resin and polylactic acid are used as resins of which the stretched film is composed; the proportion of the resins in the stretched film is high; and a value calculated by multiplying the weight-average molecular weight of the poly(3-hydroxyalkanoate) resin by the weight proportion of the polylactic acid is equal to or greater than a predetermined value.

Specifically, one or more embodiments of the present invention relate to a stretched film containing a resin component, wherein
the resin component contains a poly(3-hydroxyalkanoate) resin (A) and a polylactic acid resin (B),
the poly(3-hydroxyalkanoate) resin (A) contains a copolymer (A1) of 3-hydroxybutyrate units and other hydroxyalkanoate units, and a poly(3-hydroxybutyrate) resin (A2),
a proportion of the resin component in the stretched film is more than 99.6 wt %, and
the following inequality (I) is satisfied:
Inequality (I): (Ma÷10⁴)×Wb≥1600, wherein Ma is a weight-average molecular weight of the total poly(3-hydroxyalkanoate) resin (A), and Wb is a proportion (wt %) of the polylactic acid resin (B) in a total amount of the poly(3-hydroxyalkanoate) resin (A) and the polylactic acid resin (B).

One or more embodiments of the present invention also relate to a laminate including:
a core layer; and
a surface layer located on at least one side of the core layer, wherein
the surface layer includes the stretched film described above.

One or more embodiments of the present invention can provide a poly(3-hydroxyalkanoate) resin-containing stretched film that can be produced with good productivity and good stretchability and that exhibits both low haze and good printability.

One or more embodiments of the present invention can also provide a resin film having good biodegradability.

### DETAILED DESCRIPTION

Hereinafter, one or more embodiments of the present invention will be described in detail. It should be understood that the present invention is not limited to the embodiments described below, and various modifications may be made within the scope defined by the appended claims. The features described below may be combined in any manner, and such combinations should be considered to constitute one aspect of one or more embodiments of the present invention.

A stretched film according to the present disclosure contains a resin component, and the resin component contains at least a poly(3-hydroxyalkanoate) resin (A) and a polylactic acid resin (B). These resins will be described individually below.

### [Poly(3-Hydroxyalkanoate) Resin (A)]

The poly(3-hydroxyalkanoate) resin (A) is a polymer having 3-hydroxyalkanoate units. In particular, the poly(3-hydroxyalkanoate) resin (A) may be a polymer containing units represented by the following formula (1).

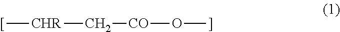

In the formula (1), R is an alkyl group represented by CₚH₂ₚ₊₁, and p is an integer from 1 to 15. Examples of R include linear or branched alkyl groups such as methyl, ethyl, propyl, methylpropyl, butyl, isobutyl, t-butyl, pentyl, and hexyl groups. The integer p may be from 1 to 10 or from 1 to 8.

The poly(3-hydroxyalkanoate) resin (A) may be a microbially produced poly(3-hydroxyalkanoate) resin. In microbially produced poly(3-hydroxyalkanoate) resins, all 3-hydroxyalkanoate units are contained as (R)-3-hydroxyalkanoate units.

The poly(3-hydroxyalkanoate) resin (A) may contain 50 mol % or more, 60 mol % or more, or 70 mol % or more, of 3-hydroxyalkanoate units (in particular, the units represented by the formula (1)) in the total structural units. The poly(3-hydroxyalkanoate) resin (A) may contain only one type or two or more types of 3-hydroxyalkanoate units as polymer structural units, or may contain other units (such as 4-hydroxyalkanoate units) in addition to one type or two or more types of 3-hydroxyalkanoate units.

In the stretched film according to the present disclosure, the poly(3-hydroxyalkanoate) resin (A) contains a copolymer (A1) of 3-hydroxybutyrate units and other hydroxyalkanoate units and a poly(3-hydroxybutyrate) resin (A2). This makes it possible to ensure both good film productivity and good mechanical properties of the film.

The copolymer (A1) of 3-hydroxybutyrate units and other hydroxyalkanoate units is a copolymer containing at least 3-hydroxybutyrate (hereinafter also referred to as 3HB) units. In particular, all of the 3-hydroxybutyrate units may be (R)-3-hydroxybutyrate units.

Specific examples of the copolymer (A1) include poly(3-hydroxybutyrate-co-3-hydroxypropionate), poly(3-hydroxybutyrate-co-3-hydroxyvalerate) abbreviated as P3HB3HV, poly(3-hydroxybutyrate-co-3-hydroxyvalerate-co-3-hydroxyhexanoate), poly(3-hydroxybutyrate-co-3-hydroxyhexanoate) abbreviated as P3HB3HH, poly(3-hydroxybutyrate-co-3-hydroxyheptanoate), poly(3-hydroxybutyrate-co-3-hydroxyoctanoate), poly(3-hydroxybutyrate-co-3-hydroxynonanoate), poly(3-hydroxybutyrate-co-3-hydroxydecanoate), poly(3-hydroxybutyrate-co-3-hydroxyundecanoate), and poly(3-hydroxybutyrate-co-4-hydroxybutyrate) abbreviated as P3HB4HB. In particular, poly(3-hydroxybutyrate-co-3-hydroxyhexanoate) or poly(3-hydroxybutyrate-co-4-hydroxybutyrate) is preferred in terms of film productivity and the mechanical properties of the film.

Poly(3-hydroxybutyrate-co-3-hydroxyhexanoate) is particularly preferred for the following reasons: its melting point and crystallinity can be changed by varying the proportions of the repeating units, and thus its physical properties such as Young's modulus and heat resistance can be adjusted and controlled to levels intermediate between those of polypropylene and polyethylene; and poly(3-hydroxybutyrate-co-3-hydroxyhexanoate) is a plastic that is easy to industrially produce and has useful physical properties. Poly(3-hydroxyalkanoate) resins are readily thermally decomposed under heating at 180° C. or higher and, in particular, poly(3-hydroxybutyrate-co-3-hydroxyhexanoate) can have a low melting point and be moldable at low temperatures. Poly(3-hydroxybutyrate-co-3-hydroxyhexanoate) is preferred also in this respect.

Examples of commercially available poly(3-hydroxybutyrate-co-3-hydroxyhexanoate) include “Kaneka Biodegradable Polymer Green Planet™” of Kaneka Corporation.

The proportion of the copolymer (A1) in the poly(3-hydroxyalkanoate) resin (A) may be increased in order to reduce the haze of the film. Specifically, the proportion of the copolymer (A1) may be 60 wt % or more, 70 wt % or more, 75 wt % or more, or 80 wt % or more.

In order to improve the ease of solidification of the resin (A) and thereby enhance film productivity, the proportion of the copolymer (A1) in the resin (A) may be 95 wt % or less or 90 wt % or less.

The weight-average molecular weight of the copolymer (A1) is not limited to a particular range. In terms of film productivity and stretchability, the weight-average molecular weight may be from 20×10⁴ to 80×10⁴, from 30×10⁴ to 70×10⁴, or from 40×10⁴ to 65×10⁴.

The weight-average molecular weight of a poly(3-hydroxyalkanoate) resin or copolymer can be measured as a polystyrene-equivalent molecular weight by gel permeation chromatography (HPLC GPC system manufactured by Shimadzu Corporation) using a chloroform solution of the resin or copolymer. The columns used in the gel permeation chromatography may be any columns suitable for weight-average molecular weight measurement. The same applies to the following description.

In terms of the physical properties of the film and film productivity, the copolymer (A1) may include a copolymer (A1-1) that contains 3-hydroxybutyrate units and other hydroxyalkanoate units and in which the proportion of the 3-hydroxybutyrate units is from 76 to 99 mol %. The proportion of the 3-hydroxybutyrate units in the copolymer (A1-1) may be 80 mol % or more, 85 mol % or more, or 88 mol % or more. The proportion may be 97 mol % or less or 95 mol % or less. The copolymer (A1-1) may be a combination of two copolymers that satisfy the above requirement for the proportion of 3-hydroxybutyrate units. These two copolymers differ in the types and proportions of the constituent monomers.

Any of the above-mentioned specific examples of the copolymer (A1) may be used as the copolymer (A1-1). Poly(3-hydroxybutyrate-co-3-hydroxyhexanoate) or poly(3-hydroxybutyrate-co-4-hydroxybutyrate) is preferred, and poly(3-hydroxybutyrate-co-3-hydroxyhexanoate) is particularly preferred.

The proportion of the copolymer (A1-1) in the copolymer (A1) may be from 40 to 100 wt %, 60 wt % or more, 80 wt % or more, 90 wt % or more, 95 wt % or more, or 99 wt % or more.

The copolymer (A1) may further include, in addition to the copolymer (A1-l), a copolymer (A1-2) that contains 3-hydroxybutyrate units and other hydroxyalkanoate units and in which the proportion of the 3-hydroxybutyrate units is less than 76 mol %. The proportion of the 3-hydroxybutyrate units in the polymer (Al-2) may be from 1 to less than 76 mol %, from 50 to 75 mol %, from 60 to 74 mol %, or from 70 to 74 mol %. The copolymer (A1) need not necessarily include the copolymer (A1-2).

Any of the above-mentioned specific examples of the copolymer (A1) may be used as the copolymer (A1-2). Poly(3-hydroxybutyrate-co-3-hydroxyhexanoate) or poly(3-hydroxybutyrate-co-4-hydroxybutyrate) is preferred, and poly(3-hydroxybutyrate-co-3-hydroxyhexanoate) is particularly preferred.

The copolymer (A1) may further include, in addition to the copolymer (A1-1) and/or the copolymer (A1-2), a copolymer of 3-hydroxybutyrate units and other hydroxyalkanoate units that falls outside the definitions of the copolymers (Al-1) and (Al-2).

The stretched film according to the present disclosure contains a poly(3-hydroxybutyrate) resin (A2) together with the copolymer (A1) of 3-hydroxybutyrate units and other hydroxyalkanoate units. The resin (A2) is a high-crystallinity resin, and incorporation of this resin enhances film productivity and enables film molding at a high production speed. Accordingly, film molding can be accomplished with high productivity even when the amount of a nucleating agent such as a fatty acid amide or a sugar alcohol is reduced. Reducing the amount of the nucleating agent can lead to low haze of the stretched film.

The term “poly(3-hydroxybutyrate) resin (A2)” refers to a homopolymer of 3-hydroxybutyrate or a polymer containing 3-hydroxybutyrate units and a small amount of other hydroxyalkanoate units. Specifically, the proportion of 3-hydroxybutyrate units in the total constituent monomers of the poly(3-hydroxybutyrate) resin (A2) may be more than 99 mol % and up to 100 mol %.

The hydroxyalkanoate units other than 3-hydroxybutyrate units that may be contained in the poly(3-hydroxybutyrate) resin (A2) are not limited to a particular type, and may be any hydroxyalkanoate units copolymerizable with 3-hydroxybutyrate units. Examples include 3-hydroxyalkanoate units other than 3-hydroxybutyrate units and hydroxyalkanoate units other than 3-hydroxyalkanoate units (such as 4-hydroxyalkanoate units). Among these, 3-hydroxyhexanoate units are preferred.

The weight-average molecular weight of the poly(3-hydroxybutyrate) resin (A2) is not limited to a particular range. In terms of film productivity and stretchability, the weight-average molecular weight may be from 5×10⁴ to 80×10⁴, from 10×10⁴ to 70×10⁴, from 15×10⁴ to 60×10⁴, or from 20×10⁴ to 50×10⁴.

The proportion of the poly(3-hydroxybutyrate) resin (A2) in the poly(3-hydroxyalkanoate) resin (A) may be increased in order to improve the ease of solidification of the resin (A) and thereby enhance film productivity. Specifically, the proportion may be 5 wt % or more or 10 wt % or more.

In order to reduce the amount of foreign matter in the film and thereby reduce the haze of the film, the proportion may be 40 wt % or less, 30 wt % or less, 25 wt % or less, or 20 wt % or less.

The poly(3-hydroxyalkanoate) resin (A) may consist solely of the copolymer (A1) and the resin (A2) or may further contain, in addition to the copolymer (A1) and the resin (A2), a poly(3-hydroxyalkanoate) resin that falls outside the definitions of the copolymer (A1) and the resin (A2).

The total proportion of the copolymer (A1) and the resin (A2) in the poly(3-hydroxyalkanoate) resin (A) may be from 70 to 100 wt %, 80 wt % or more, 90 wt % or more, 95 wt % or more, or 99 wt % or more.

The average ratio between 3-hydroxybutyrate units and other hydroxyalkanoate units (3-hydroxybutyrate units/other hydroxyalkanoate units) in the total monomer units constituting the poly(3-hydroxyalkanoate) resin (A) may be from 99/1 to 80/20 (mol %/mol %), from 97/3 to 82/18 (mol %/mol %), or from 95/5 to 85/15 (mol %/mol %) in order to ensure both good mechanical properties of the film and good film productivity.

The average ratio between different monomer units in the total monomer units constituting the poly(3-hydroxyalkanoate) resin (A) can be determined by a method known to those skilled in the art, such as the method described in paragraph [0047] of WO 2013/147139 A1. The “average ratio” refers to the molar ratio between different monomer units in the total monomer units constituting the poly(3-hydroxyalkanoate) resin (A), that is, the molar ratio between different monomer units contained in the total mixture containing the copolymer (A1) and the resin (A2).

The weight-average molecular weight Ma of the total poly(3-hydroxyalkanoate) resin (A) may be 20×10⁴ or more, 30×10⁴ or more, 40×10⁴ or more, or 50×10⁴ or more in order to reduce the haze of the stretched film. To further enhance film productivity, the weight-average molecular weight Ma may be 80×10⁴ or less, 70×10⁴ or less, or 65×10⁴ or less.

An unmodified poly(3-hydroxyalkanoate) resin can be used as the poly(3-hydroxyalkanoate) resin (A). Alternatively, a resin obtained by modifying an unmodified poly(3-hydroxyalkanoate) resin with a resin-reactive material such as a peroxide (hereinafter referred to as a “modifying material”) may be used.

When a modified resin is used as a film raw material, the modified resin may first be obtained through reaction of a resin and a modifying material and then molded into a film. Alternatively, a resin may be mixed with a modifying material, and they may be reacted during film molding. When a resin is reacted with a modifying material, the whole amount of the resin may be reacted at once with the modifying material. Alternatively, part of the resin may be reacted with the modifying material to obtain a modified resin, and then the rest of the unmodified resin may be added to the modified resin.

The modifying material is not limited to a particular compound, and may be any compound reactive with poly(3-hydroxyalkanoate) resins. In terms of handleability and ease of control of the reaction with poly(3-hydroxyalkanoate) resins, the use of an organic peroxide is preferred. The organic compound used may be any suitable known compound.

The method for producing the poly(3-hydroxyalkanoate) resin (A) is not limited to a particular technique, and may be a production method using chemical synthesis or a microbial production method. A microbial production method is preferred. The microbial production method used can be any known method. Known examples of bacteria that produce copolymers of 3-hydroxybutyrate with other hydroxyalkanoates include Aeromonas caviae which is a P3HB3HV- and P3HB3HH-producing bacterium and Alcaligenes eutrophus which is a P3HB4HB-producing bacterium. In particular, in order to increase P3HB3HH productivity, Alcaligenes eutrophus AC32 (FERM BP-6038; see T. Fukui, Y Doi, J. Bacteriol., 179, pp. 4821-4830 (1997)) incorporating a P3HA synthase gene is more preferred. Such a microorganism is cultured under suitable conditions to allow the microorganism to accumulate P3HB3HH in its cells, and the microbial cells accumulating P3HB3HH are used. Instead of the above microorganisms, a genetically modified microorganism incorporating any suitable poly(3-hydroxyalkanoate) resin synthesis-related gene may be used depending on the poly(3-hydroxyalkanoate) resin to be produced. The culture conditions including the type of the substrate may be optimized depending on the poly(3-hydroxyalkanoate) resin to be produced.

The method for obtaining a blend of two or more poly(3-hydroxyalkanoate) resins is not limited to a particular technique. A blend of two or more poly(3-hydroxyalkanoate) resins may be obtained by microbial production or chemical synthesis. Alternatively, a blend of two or more resins may be obtained by melting and kneading the resins using a device such as an extruder, a kneader, a Banbury mixer, or a roll mill, or may be obtained by dissolving and mixing the resins in a solvent and drying the resulting mixture.

In the stretched film according to the present disclosure, the amount of the poly(3-hydroxyalkanoate) resin (A) may be from 30 to 80 wt % based on the total amount of the poly(3-hydroxyalkanoate) resin (A) and the polylactic acid resin (B) in order to achieve good biodegradability while ensuring both good film productivity and good film stretchability. In order to enhance the biodegradability of the film, the amount of the poly(3-hydroxyalkanoate) resin (A) may be at least 35 wt %, at least 40 wt %, or at least 50 wt %. The amount may be at least 60 wt %. In order to improve film productivity and stretchability, the amount may be up to 75 wt % or up to 70 wt %. The amount may be up to 65 wt % or up to 60 wt %.

### [Polylactic Acid Resin (B)]

The polylactic acid resin (B) is a polyester containing lactic acid as a constituent monomer. Generally, polylactic acid resins have a glass transition temperature of around 60° C. and, when rapidly cooled from a molten state, they do not readily crystallize but become amorphous. Thus, incorporation of the polylactic acid resin (B) into a film facilitates softening of the film. Accordingly, incorporation of the polylactic acid resin (B) can enhance the stretchability of a poly(3-hydroxyalkanoate) resin-containing film. This makes it possible to prevent film breakage during stretching and obtain a high-quality stretched film without uneven stretching. In addition, high stretch ratios can be achieved. Furthermore, deterioration of film haze due to stretching can also be prevented.

The polylactic acid resin (B) may be a homopolymer of lactic acid, but may contain a small amount of a monomer other than lactic acid.

The lactic acid of the polylactic acid resin (B) may be either L-lactic acid or D-lactic acid or may be a combination of both. In the latter case, the ratio between L-lactic acid and D-lactic acid is not limited to a particular range.

The polylactic acid resin (B) may be a poly(L-lactic acid) resin, a poly(D-lactic acid) resin, or a poly(DL-lactic acid) resin. A blend of these resins may be used.

Examples of the other monomer that may be contained in the polylactic acid resin (B) include aliphatic hydroxycarboxylic acids other than lactic acid, aliphatic polyhydric alcohols, aliphatic polycarboxylic acids, and polyfunctional polysaccharides.

When the polylactic acid resin (B) is a copolymer of lactic acid and another monomer, in terms of crystallinity, the proportion of the other monomer in the total monomers contained in the polylactic acid resin (B) may be from about 0 to about 3 mol %. The proportion may be from 0 to 2 mol %.

The polylactic acid resin (B) may be either a crystalline polylactic acid resin or an amorphous polylactic acid resin. In terms of film heat resistance, the use of a crystalline polylactic acid resin is preferred. Among crystalline polylactic acid resins, a polylactic acid resin that exhibits a melting point peak with a peak temperature below 170° C. in differential scanning calorimetry is particularly preferred.

The peak temperature of the melting point peak of the polylactic acid resin (B) (hereinafter also referred to as the “melting point peak temperature”) may be 165° C. or lower or 160° C. or lower in order to enhance film stretchability and mechanical properties. The peak temperature may be at least 120° C., at least 130° C., or at least 140° C. in order to enhance film stretchability.

The “melting point peak temperature” refers to a peak top temperature Tm of a crystalline melting peak in a DSC curve obtained by differential scanning calorimetry (DSC). The DSC curve is obtained by weighing about 5 mg of the resin to be analyzed and heating the weighed resin from 0 to 200° C. at a rate of 10° C./min in a differential scanning calorimeter.

The polylactic acid resin (B) which exhibits a melting point peak temperature as described above is not limited to a particular resin and may be a commercially available product. Specific examples include polylactic acid resins in which L-lactic acid constitutes 88 to 98% of the lactic acid units.

The molecular weight of the polylactic acid resin (B) is not limited to a particular range. In order to reliably obtain a stretched film with low haze, the number-average molecular weight of the polylactic acid resin (B) may be from 5×10⁴ to 70×10⁴, from 10×10⁴ to 50×10⁴, from 15×10⁴ to 40×10⁴, or from 20×10⁴ to 30×10⁴.

The lactic acid material used to produce the polylactic acid resin (B) is not limited to a particular type, and L-lactic acid, D-lactic acid, DL-lactic acid, or a mixture thereof may be used. Alternatively, L-lactide, D-lactide, meso-lactide, or a mixture thereof may also be used. Lactic acid obtained by microbial fermentation of a plant-derived renewable material such as starch can be suitably used.

The method for producing the polylactic acid resin (B) is not limited to a particular technique and may be any known method such as dehydration polycondensation or ring-opening polymerization.

The stretched film according to the present disclosure satisfies the following inequality (I). This feature enables the stretched film to achieve low haze.

$$Inequality ( I ) : ( Ma \div {10}^{4} ) \times Wb ≧ 1600$$

Ma: Weight-average molecular weight of total poly(3-hydroxyalkanoate) resin (A)
Wb: Proportion (wt %) of polylactic acid resin (B) in total amount of poly(3-hydroxyalkanoate) resin (A) and polylactic acid resin (B)

The present inventors have found that an increase in the molecular weight of the poly(3-hydroxyalkanoate) resin (A) tends to reduce the haze of the stretched film. In the case where the resin (A) has a relatively low molecular weight, it is inferred that when the molecular chains of the resin (A) are oriented during film stretching, they are not sufficiently entangled, leaving tiny gaps that produce microscopic irregularities on the film surface, which deteriorate (increase) the haze (particularly external haze) of the film.

In addition, the present inventors have found that an increase in the proportion of the polylactic acid resin (B) in the film tends to enhance film productivity and stretchability and also to reduce the haze of the stretched film. This is presumably because the polylactic acid resin (B) softens more readily than the poly(3-hydroxyalkanoate) resin (A) during stretching, so that increasing the amount of the polylactic acid resin (B) improves film stretchability.

The inequality (I) shown above comprehensively represents the influence of the molecular weight of the poly(3-hydroxyalkanoate) resin (A) and the influence of the proportion of the polylactic acid resin (B) on haze reduction. The present inventors have found that the product of the weight-average molecular weight Ma of the total resin (A) and the weight proportion Wb of the polylactic acid resin (B) correlates with the haze exhibited by the stretched film. Based on this finding, the product value is used as a parameter for obtaining a stretched film with low haze.

The weight-average molecular weight Ma of the total poly(3-hydroxyalkanoate) resin (A) refers to the weight-average molecular weight measured for the whole of the resin (A) prepared as a raw material prior to film formation.

The inequality (I) specifies that the value calculated as (Ma÷10⁴)×Wb is 1600 or more. When this requirement is satisfied, a stretched film with low haze can be obtained, and high stretch ratios can also be achieved. The calculated value may be 1800 or more or 2000 or more. The upper limit of the calculated value is not limited to a particular value. In terms of film productivity and biodegradability, the calculated value may be up to 4000 or up to 3500. The calculated value may be up to 3000 or up to 2500.

The proportion Wb of the polylactic acid resin (B) in the total amount of the poly(3-hydroxyalkanoate) resin (A) and the polylactic acid resin (B) may be 20 wt % or more, 25 wt % or more, or 30 wt % or more in order to reduce the haze of the stretched film and enhance film productivity and stretchability. The proportion Wb may be 35 wt % or more or may be 40 wt % or more. The proportion Wb may be up to 70 wt %, up to 65 wt %, up to 60 wt %, or up to 50 wt % in order to enhance the biodegradability of the film (in particular, biodegradability in compositing and marine degradability). The proportion Wb may be 40 wt % or less.

The weight-average molecular weight Ma of the total poly(3-hydroxyalkanoate) resin (A) may be 20×10⁴ or more, 30×10⁴ or more, 40×10⁴ or more, or 50×10⁴ or more in order to reliably obtain a stretched film with low haze. To further improve film productivity, the weight-average molecular weight Ma may be 80×10⁴ or less, 70×10⁴ or less, or 65×10⁴ or less.

The weight-average molecular weight Mab of the total of the poly(3-hydroxyalkanoate) resin (A) and the polylactic acid resin (B) may be 20×10⁴ or more, 25×10⁴ or more, 30×10⁴ or more, or 40×10⁴ or more in order to reliably obtain a stretched film with low haze. To further improve film productivity, the weight-average molecular weight Mab may be 60×10⁴ or less, 50×10⁴ or less, or 45×10⁴ or less.

The stretched film according to the present disclosure is a resin film primarily composed of the poly(3-hydroxyalkanoate) resin (A) and the polylactic acid resin (B). The total proportion of the poly(3-hydroxyalkanoate) resin (A) and the polylactic acid resin (B) in the resin component of the stretched film may be 50 wt % or more, and may be 70 wt % or more, 80 wt % or more, or 90 wt % or more. The total proportion may be 95 wt % or more, 98 wt % or more, 99 wt % or more, or 99.5 wt % or more. The upper limit of the total proportion is not limited to a particular value, and the total proportion may be 100 wt % or less.

The stretched film according to the present disclosure may contain an additional resin other than the poly(3-hydroxyalkanoate) resin (A) and the polylactic acid resin (B), and examples of such additional resins include: aliphatic polyester resins such as polybutylene succinate adipate, polybutylene succinate, and polycaprolactone; and aliphatic-aromatic polyester resins such as polybutylene adipate terephthalate, polybutylene sebacate terephthalate, and polybutylene azelate terephthalate. The stretched film may contain only one additional resin or two or more additional resins.

The stretched film according to the present disclosure consists essentially of the resin component, and contains no or very small amounts of additives in addition to the resin component. Specifically, the proportion of the resin component in the stretched film is more than 99.6 wt % and up to 100 wt %. When the amount of additives contained in addition to the resin component is extremely small as in this case, interference of any additive with a printing ink can be avoided, and printability on the surface of the stretched film can be improved. The haze of the stretched film can also be reduced.

The proportion of the resin component in the stretched film may be at least 99.65 wt % in order to improve printability on the surface of the stretched film and achieve low haze of the stretched film. The proportion of the resin component may be 99.7 wt % or more, 99.8 wt % or more, or 99.9 wt % or more. The proportion of the resin component may be up to 99.9 wt %, up to 99.8 wt %, or up to 99.7 wt % in order to permit incorporation of an organic nucleating agent described later and thereby improve film productivity.

Examples of additives that may be contained in the stretched film according to the present disclosure include: nucleating agents; lubricants; colorants such as pigments and dyes; odor absorbers such as activated carbon and zeolite; flavors such as vanillin and dextrin; fillers; plasticizers; oxidation inhibitors; antioxidants; weathering resistance improvers; ultraviolet absorbers; mold release agents; water-repellent agents; antimicrobial agents; and slidability improvers. The stretched film may contain only one additive or may contain two or more additives. The amounts of these additives can be set by those skilled in the art as appropriate depending on the intended purpose.

The stretched film according to the present disclosure may contain an organic nucleating agent, provided that the proportion of the resin component in the stretched film satisfies the requirement described above. In this case, film productivity can be further enhanced while achieving low haze. It should be noted that the stretched film need not necessarily contain any organic nucleating agent and that good film productivity can be achieved even in the absence of any organic nucleating agent.

Examples of organic nucleating agents include: sugar alcohols such as pentaerythritol, galactitol, and mannitol; fatty acid amides; and other compounds such as orotic acid, aspartame, cyanuric acid, and glycine. One organic nucleating agent may be used alone, or two or more organic nucleating agents may be used. The proportions of the organic nucleating agents used can be adjusted as appropriate depending on the intended purpose.

Sugar alcohols and/or fatty acid amides are preferred as organic nucleating agents because they are particularly effective in accelerating the crystallization of the poly(3-hydroxyalkanoate) resin (A). In particular, fatty acid amides are preferred to avoid deterioration of printability.

The fatty acid amide to be used is not limited to a particular compound, and may be any component known as a lubricant. Specific examples include behenamide, oleamide, erucamide, stearamide, palmitamide, N-stearyl behenamide, N-stearyl erucamide, ethylene bis(stearamide), ethylene bis(oleamide), ethylene bis(erucamide), ethylene bis(lauramide), ethylene bis(capramide), p-phenylene bis(stearamide), and a polycondensation product of ethylenediamine, stearic acid, and sebacic acid. Among these, behenamide and erucamide are preferred because they are particularly effective in accelerating the crystallization of the poly(3-hydroxyalkanoate) resin (A) and in lubricating the resin (A). One fatty acid amide may be used alone, or two or more fatty acid amides may be used. The proportions of the fatty acid amides used can be adjusted as appropriate depending on the intended purpose.

The amount of organic nucleating agents may be such that the proportion of the resin component in the stretched film satisfies the requirement described above. Specifically, the proportion of organic nucleating agents in the stretched film is from 0 to less than 0.4 wt %. In order to improve film productivity, the proportion may be at least 0.1 wt %, at least 0.2 wt %, or at least 0.3 wt %. In order to improve printability on the surface of the stretched film and reduce the haze of the stretched film, the proportion may be up to 0.35 wt %. The proportion may be 0.3 wt % or less, 0.2 wt % or less, or 0.1 wt % or less. The term “proportion of organic nucleating agents in the stretched film” may be interchangeably used with the “proportion of fatty acid amides in the stretched film.”

In the stretched film according to the present disclosure, it is preferable to reduce the amount of sugar alcohols such as, in particular, pentaerythritol. This reduction can further improve printability on the stretched film. Specifically, the proportion of sugar alcohols in the stretched film may be from 0 to 0.3 wt %, 0.2 wt % or less, 0.1 wt % or less, or 0.01 wt % or less.

In the stretched film according to the present disclosure, it is preferable to reduce the amount of layered clay minerals. This reduction can further decrease the haze of the stretched film. Layered clay minerals are typically incorporated as fillers into resin materials, and specific examples include smectite, mica, talc, pyrophyllite, vermiculite, chlorite, kaolinite, and serpentine. Specifically, the proportion of layered clay minerals in the stretched film may be from 0 to 0.3 wt %, 0.2 wt % or less, 0.1 wt % or less, or 0.01 wt % or less.

### [Stretched Film]

The stretched film according to the present disclosure is produced by film molding followed by stretching in an MD direction and/or a TD direction. Such stretching can enhance the strength of the film while reducing its thickness.

In general, stretching a film containing the poly(3-hydroxyalkanoate) resin (A) tends to deteriorate (increase) the haze of the film. However, the film composition according to the present disclosure can suppress such haze deterioration caused by stretching, thereby enabling the resulting stretched film to exhibit low haze.

In terms of thickness uniformity, appearance, strength, and low weight, the thickness of the stretched film according to the present disclosure may be from 10 to 200 μm, from 15 to 150 μm, or from 20 to 100 μm.

The stretched film according to the present disclosure may be an industrially produced long film, or a strip-shaped film wound into a roll. The length of such a film is not limited to a particular range, and may be, for example, 50 m or more, or 100 m or more. According to the present disclosure, such a long film can be produced continuously and stably.

The stretched film according to the present disclosure is suitable for forming a printed layer on at least a portion of its surface. As described above, the stretched film according to the present disclosure consists essentially of a resin component and contains no or very small amounts of additives that interfere with printing inks. Accordingly, the stretched film has good printability, and the surface of the film is suitable for printing.

The printed layer is not limited to any particular details, and can be formed by a known printing method using a known printing ink. Examples of printing methods include gravure printing, offset printing, gravure offset printing, flexographic printing, and inkjet printing. The printing ink may be either solvent-based or water-based. The printed layer may be a single layer or composed of a plurality of layers.

A protective layer for protecting the printed layer may be formed on the printed layer. The protective layer can be selected from among known materials. For example, a solvent-based or water-based lacquer containing a resin and additives may be used.

### [Method for Producing Stretched Film]

The following describes an example of a method for producing the stretched film according to the present disclosure. The present invention is not limited by the following description.

First, a film raw material containing the poly(3-hydroxyalkanoate) resin (A), the polylactic acid resin (B), and optionally other components is melted.

The melting method is not limited to a particular technique. The molten film raw material may be extruded from a T-die; that is, extrusion molding is preferred. By extrusion molding, a film with a uniform thickness can easily be produced. The extrusion molding can be carried out using any suitable means such as a single-screw or twin-screw extruder.

The melting of the film raw material may be performed under any conditions that allow the poly(3-hydroxyalkanoate) resin (A) and the polylactic acid resin (B) to be melted. The temperature of the molten film raw material may be, for example, from about 140 to about 210° C.

Next, the molten film raw material is extruded onto a cast roll to mold the material into a film. The melt of the film raw material comes into contact with the cast roll and moves along the surface of the cast roll, thus becoming cooled and solidified.

This step may involve extruding the melt onto a single cast roll or onto a plurality of cast rolls, or may involve placing a touch roll facing a cast roll and pressing the melt extruded onto the cast roll between the touch roll and the cast roll.

An air knife or an air chamber may be used to ensure stable contact of the melt with the cast roll. The cast roll may be placed in a water bath, or an air chamber may be used, to efficiently cool the side of the melt opposite the side in contact with the cast roll.

The set temperature of the cast roll may be at least 0° C., at least 10° C., or at least 15° C. in order to reduce the tackiness of the poly(3-hydroxyalkanoate) resin (A) and improve the separability of the film from the cast roll. The set temperature of the cast roll may be higher than a temperature that is 10° C. above the glass transition temperature (Tg) of the poly(3-hydroxyalkanoate) resin (A).

The upper limit of the set temperature of the cast roll is not limited to a particular value. In order to accelerate the solidification of the poly(3-hydroxyalkanoate) resin (A), the set temperature may be up to 80° C. or up to 60° C.

Next, the film cooled on the cast roll is transferred along with rotation of the cast roll, thereby being separated from the cast roll. As a result, an unstretched film can be obtained.

The obtained film may be subsequently stretched in the MD direction to obtain a uniaxially stretched film having high strength in the MD direction. The MD direction is also referred to as the machine direction, flow direction, or longitudinal direction. The TD direction described later is a direction perpendicular to the MD direction, and is also referred to as the transverse direction or width direction.

The MD-direction stretching step can be performed directly after the separation from the cast roll on the same production line. This step is not limited to using a particular technique, and can be performed, for example, by using a roll longitudinal stretching machine including a plurality of rolls over which the film is transferred and by operating the plurality of rolls at different rotational speeds.

During the MD-direction stretching step, the film may be heated. The heating is not limited to using a particular technique, and examples of heating techniques include: a technique in which an air stream adjusted to a given temperature is applied to the film; a technique in which the film temperature is controlled by setting rolls to a given temperature; a technique in which the film temperature is controlled to a given temperature by heating the film using auxiliary heating means such as an IR heater; and a technique in which the film is passed through an oven adjusted to a given temperature. One of these techniques may be used alone, or two or more thereof may be used in combination.

In the production of the stretched film according to the present disclosure, the temperature during MD-direction stretching may be 35° C. or higher, 45° C. or higher, or 55° C. or higher. Since the stretched film according to the present disclosure contains the polylactic acid resin (B), the film can readily soften even at a temperature below the melting point of the poly(3-hydroxyalkanoate) resin (A), and successful stretching can be achieved. Accordingly, film stretching can be carried out continuously and stably, so that a long stretched film can be produced stably. In addition, a high stretch ratio can be achieved.

The upper limit of the temperature during MD-direction stretching is not limited to a particular value. In order to avoid breakage of the film during stretching, the temperature may be up to 110° C., up to 100° C., or up to 90° C.

The stretch ratio in the MD direction is not limited to a particular range, but may be 2 or more. The stretch ratio may be 2.5 or more or 3 or more. Such a high stretch ratio can be achieved by virtue of the composition of the stretched film raw material according to the present disclosure. The upper limit of the stretch ratio is not limited to a particular value, and may be chosen as appropriate. For example, the stretch ratio may be up to 8.

The MD-direction stretching may be followed by stretching in the TD direction to obtain a biaxially stretched film having high strength in both the MD and TD directions. The TD-direction stretching step can be carried out directly after the MD-direction stretching step on the same production line. This step is not limited to using a particular technique, and can be performed, for example, by using a transverse stretching machine such as a clip tenter to clamp the film at both width ends and pull the clamped film in the TD direction.

The film may be heated also during the TD-direction stretching step. The heating is not limited to using a particular technique, and any of the heating techniques described above for the MD-direction stretching step may be used.

The temperature during TD-direction stretching may be set similarly to the temperature during MD-direction stretching, and may be from 35 to 110° C., from 45 to 100° C., or from 55 to 90° C.

The stretch ratio in the TD direction is not limited to a particular range, but may be 2 or more. The stretch ratio may be 3 or more, 4 or more, or 5 or more. Such a high stretch ratio can be achieved by virtue of the composition of the stretched film according to the present disclosure. The upper limit of the stretch ratio is not limited to a particular value and may be chosen as appropriate. For example, the stretch ratio may be up to 8.

After the MD-direction or TD-direction stretching step, it is preferable to perform a heat setting step in which the stretched film is heated to a temperature that allows high-melting-point crystals to grow. This step can increase the crystallinity and hence the strength of the stretched film, and can also stabilize the physical properties of the stretched film.

The heating temperature during the heat setting may be from 80 to 150° C., from 90 to 135° C., or from 100 to 130° C.

The heat setting can be carried out, for example, by heating the stretched film while maintaining its stretched state after TD-direction stretching performed using a transverse stretching machine such as a clip tenter. During this step, since the film thermally shrinks in a direction opposite to the stretch direction, relaxation may be performed to prevent breakage of the film. The relaxation is a procedure in which the film is allowed to retract in the direction opposite to the stretch direction. The amount of relaxation may be adjusted as appropriate between 5% and 30%.

Subsequently, the step of cooling the film may be performed as appropriate. Subsequently, the step of winding the stretched film onto a take-up roll may be performed.

In the stretched film production method according to the present disclosure, it is preferable to transfer the film continuously throughout all steps from melt extrusion to the final step. In this case, film production with good productivity can be accomplished by an industrially simple process. The production method according to the present disclosure can be carried out while continuously winding the produced film onto a take-up roll.

When the stretched film is continuously transferred, the transfer speed is not limited to a particular range. In terms of film productivity, the transfer speed may be 10 m/min or higher, 15 m/min or higher, or 18 m/min or higher before the start of stretching. In terms of production stability, the transfer speed may be 50 m/min or lower before the start of stretching.

### [Laminate]

The stretched film according to the present disclosure may be a resin film consisting of a single self-supporting layer (optionally including a printed layer as described above). Alternatively, a laminate may be formed by placing another layer on one or both sides of the stretched film. Such a laminate is also one aspect of one or more embodiments of the present invention. A printed layer can be suitably provided on at least a portion of the surface of the stretched film in the laminate.

Examples of the other layer included in the laminate include a resin layer, an inorganic layer, a metal layer, and a metal oxide layer. These other layers may be lamination layers, coating layers, or vapor-deposited layers.

The resin layer, which is one form of the other layer in the laminate, is not limited to a particular type. In order to enhance the biodegradability of the laminate as a whole, the resin layer may be a layer containing a poly(3-hydroxyalkanoate) resin (C). The poly(3-hydroxyalkanoate) resin (C) is not limited to a particular type, and may be any of the poly(3-hydroxyalkanoate) resins described above for the poly(3-hydroxyalkanoate) resin (A). Components other than the poly(3-hydroxyalkanoate) resin (C) are not limited to particular materials, and another resin and any components known as additives for resin layers may be used as appropriate. The resin layer may be a stretched layer to ensure sufficient strength.

An aspect of the present disclosure can provide a laminate including a core layer for ensuring sufficient strength of the laminate as a whole and a surface layer located on at least one side of the core layer, and the stretched film according to the present disclosure can be used as the surface layer. The core layer may be the resin layer described above, and the resin layer may have a greater thickness than the stretched film according to the present disclosure.

In the laminate, the stretched film according to the present disclosure may be located on both sides of the core layer. In this case, printed layers can be provided on both sides of the laminate. That is, each layer formed of the stretched film according to the present disclosure may include a printed layer on at least a portion of its surface.

The layer formed of the stretched film according to the present disclosure can also function as a heat-sealable layer.

Since such a laminate includes, on both sides, stretched film layers according to the present disclosure which have low haze (in particular, low external haze), the haze (in particular, external haze) of the laminate as a whole can be reduced. Accordingly, when the laminate is used for packaging purposes, the packaged product can be visually recognized through the laminate.

The method for producing the laminate is not limited to a particular technique, and various lamination methods can be suitably used. Examples of lamination methods include extrusion lamination, coextrusion lamination, dry lamination, wet lamination, hot-melt lamination, and thermal lamination. Extrusion lamination, coextrusion lamination, and thermal lamination are preferred because these methods do not require the use of any adhesive, but allows the core layer and the layer formed of the stretched film according to the present disclosure to be placed directly on each other, and can achieve good interlayer adhesion. More preferred are extrusion lamination and coextrusion lamination.

### [Applications of Stretched Film and Laminate]

The stretched film according to the present disclosure, or a laminate including a layer of the stretched film and another layer, is suitable for use as a packaging material. Heat sealing can be carried out by utilizing the stretched film or the stretched film layer, and the stretched film or the laminate may be formed into a molded article (e.g., any type of bag) including a fused portion formed by heat sealing of the stretched film or the stretched film layer.

Examples of such molded articles include, but are not limited to, packaging bags such as side-seal packs, three-side-seal packs, pillow packs, and standing pouches. Specific examples include various packaging materials or containers such as shopping bags, various other types of bags, packaging materials for foods or confectionery products, cups, trays, and cartons.

The heating temperature during the heat sealing is not limited to a particular range, and may, for example, be in the range of 100 to 200° C. Since the stretched film according to the present disclosure exhibits good heat sealability at relatively low temperatures, the heat sealing may be carried out, for example, at 125° C. or lower, at 120° C. or lower, or at 115° C. or lower.

The heat sealing may be carried out between different portions of the stretched film according to the present disclosure or the stretched film layer. However, the heat sealing may alternatively be carried out between the stretched film according to the present disclosure or the stretched film layer and the other layer described above.

In the following items, aspects of the present disclosure are listed. The present invention is not limited to the following items.

### [Item 1]

A stretched film containing a resin component, wherein
the resin component contains a poly(3-hydroxyalkanoate) resin (A) and a polylactic acid resin (B),
the poly(3-hydroxyalkanoate) resin (A) contains a copolymer (A1) of 3-hydroxybutyrate units and other hydroxyalkanoate units, and a poly(3-hydroxybutyrate) resin (A2),
a proportion of the resin component in the stretched film is more than 99.6 wt %, and
the following inequality (I) is satisfied:
Inequality (I): (Ma÷10⁴)×Wb≥1600, wherein Ma is a weight-average molecular weight of the total poly(3-hydroxyalkanoate) resin (A), and Wb is a proportion (wt %) of the polylactic acid resin (B) in a total amount of the poly(3-hydroxyalkanoate) resin (A) and the polylactic acid resin (B).

### [Item 2]

The stretched film according to item 1, further containing an organic nucleating agent.

### [Item 3]

The stretched film according to item 2, wherein the organic nucleating agent is at least one selected from the group consisting of fatty acid amides and sugar alcohols.

### [Item 4]

The stretched film according to any one of items 1 to 3, wherein the proportion Wb of the polylactic acid resin (B) in the total amount of the poly(3-hydroxyalkanoate) resin (A) and the polylactic acid resin (B) is from 30 to 60 wt %.

### [Item 5]

The stretched film according to any one of items 1 to 4, wherein the weight-average molecular weight Ma of the total poly(3-hydroxyalkanoate) resin (A) is from 30×10⁴ to 70×10⁴.

### [Item 6]

The stretched film according to any one of items 1 to 5, wherein a weight-average molecular weight Mab of a total of the poly(3-hydroxyalkanoate) resin (A) and the polylactic acid resin (B) is from 25×10⁴ to 50×10⁴.

### [Item 7]

The stretched film according to any one of items 1 to 6, wherein a proportion of the poly(3-hydroxybutyrate) resin (A2) in the poly(3-hydroxyalkanoate) resin (A) is from 10 to 30 wt %.

### [Item 8]

The stretched film according to any one of items 1 to 7, wherein the copolymer (A1) includes a copolymer (A1-1) that contains 3-hydroxybutyrate units and other hydroxyalkanoate units and in which a proportion of the 3-hydroxybutyrate units is from 76 to 99 mol %.

### [Item 9]

The stretched film according to any one of items 1 to 8, wherein a total haze of the stretched film is 10% or less.

### [Item 10]

A laminate including:
a core layer; and
a surface layer located on at least one side of the core layer, wherein
the surface layer includes the stretched film according to any one of items 1 to 9.

### [Item 11]

The laminate according to item 10, wherein the surface layer is located on each side of the core layer.

### [Item 12]

The laminate according to item 10 or 11, further including a printed layer located on at least a portion of a surface of the surface layer.

### [Item 13]

The laminate according to any one of items 10 to 12, wherein the core layer contains a poly(3-hydroxyalkanoate) resin (C).

### EXAMPLES

Hereinafter, one or more embodiments of the present invention will be described in more detail with reference to Examples and Comparative Examples. The present invention is not limited by these examples in any respect.

In the examples, the following materials were used.

### (Poly(3-Hydroxyalkanoate) Resin (A))

Poly(3-hydroxybutyrate-co-3-hydroxyhexanoate) (P3HB3HH) resins A-1 and A-2 listed below were used as copolymers (Al) included in P3HA resins (A). Poly(3-hydroxybutyrate) A-3 and A-4 listed below were used as poly(3-hydroxybutyrate) resins (A2). The term “3HB” refers to 3-hydroxybutyrate repeating units, and “3HH” refers to 3-hydroxyhexanoate repeating units.
A-1: P3HB3HH (average 3HB/3HH ratio=94/6 (mol %/mol %), weight-average molecular weight=60×10⁴ g/mol)

This copolymer was produced according to the method described in Example 1 of WO 2019/142845 A1.
A-2: P3HB3HH (average 3HB/3HH ratio=94/6 (mol %/mol %), weight-average molecular weight=40×10⁴ g/mol)

This copolymer was produced according to the method described in Example 1 of WO 2019/142845 A1.
A-3: PHB (poly(3-hydroxybutyrate) (weight-average molecular weight=35×10⁴ g/mol)

This resin was produced according to the method described in Comparative Example 1 of WO 2004/041936 A1.
A-4: PHB (poly(3-hydroxybutyrate) (weight-average molecular weight=60×10⁴ g/mol)

This resin was produced according to the method described in Comparative Example 1 of WO 2004/041936 A1.

### (Polylactic Acid Resin (B))

B-1: PLA (4043D, manufactured by Nature Works, melting point peak temperature=155° C.)

### (Nucleating Agent)

C-1: Talc (SG-200 N15, manufactured by Nippon Talc Co., Ltd.)
C-2: Behenamide (BNT-22H, manufactured by Nippon Fine Chemical Co., Ltd.)
C-3: Pentaerythritol (Neulizer P, manufactured by Mitsubishi Chemical Corporation)

The following evaluations were performed in Examples and Comparative Examples.

### [Film Moldability]

Film moldability was evaluated based on a haul-off speed during T-die film production. The “haul-off speed” refers to the maximum speed at which the film can be transferred from the cast roll toward the subsequent roll without sticking to the cast roll, and serves as an indicator of whether the film has sufficiently solidified on the cast roll. If the transfer speed exceeds the haul-off speed, the point at which the film separates from the cast roll is displaced in the rotational direction of the cast roll due to the tackiness of the film, with the result that the film is forcibly peeled from the cast roll during transfer.

### [Film Stretchability]

A film was prepared from resin pellets using a T-die and then continuously stretched to three times its original length in the MD direction (the flow direction during T-die film preparation) using a roll stretching machine in the temperature range of 60 to 70° C. The stretchability in the MD direction was evaluated according to the criteria set forth below.

In addition, the film stretched in the MD direction was fixed at both ends in the MD direction and stretched to five times its original width in the TD direction (the direction perpendicular to the MD direction) in the temperature range of 70 to 80° C. The stretchability in the TD direction was evaluated according to the criteria set forth below.

### <Evaluation Criteria>

Good: A stretched film was obtained without film breakage during stretching, and the obtained film did not show any visually discernible signs of uneven stretching (unevenly stretched areas such as those with non-uniform film thickness).

Average: A stretched film was obtained without film breakage during stretching, but the obtained film showed some visually discernible signs of uneven stretching (unevenly stretched areas such as those with non-uniform film thickness).

Poor: Film breakage occurred during stretching, or the resulting film showed visually discernible signs of uneven stretching (unevenly stretched areas such as those with non-uniform film thickness) over its entirety.

### [Printability]

Using a water-based black brush pen, an ink was spread on the surface of each of the stretched films produced in Examples and Comparative Examples to examine whether the film surface was repellent to the ink.

Good: The film surface did not repel the ink.

Poor: The film surface repelled the ink.

### [Film Thickness]

The thickness of each film was measured using a caliper at 10 points spaced at intervals of 10 cm in the TD direction. The arithmetic mean of the 10 thickness values was calculated as the film thickness.

### [Film Haze Value]

The haze value of each stretched film having a thickness of 30 μm was measured using HZ-V3, a haze meter manufactured by Suga Test Instruments Co., Ltd., according to JIS K 7136-1: 1999 and K 7316: 2000.

### Example 1

The poly(3-hydroxyalkanoate) resins A-1 (31 wt %), A-3 (5 wt %), and A-4 (4 wt %) were used, and 0.5 parts by weight of the nucleating agent C-2 was dry-blended with a total of 100 parts by weight of these poly(3-hydroxyalkanoate) resins. The resulting resin material was fed into a hopper of a 26-mm-diameter corotating twin-screw extruder whose cylinder temperature and die temperature were set to 150° C. The resin material was melted and kneaded in the extruder and extruded as a strand through the die. The extruded strand was solidified by passing it through a water bath filled with hot water at 45° C. The solidified strand was cut using a pelletizer to obtain resin pellets.

The resin pellets and the polylactic acid resin B-1 were introduced into a twin-screw extruder at a weight ratio of 40:60, and the resin mixture was extruded as a film through a T-die. The resulting molded film was cooled on a cooling roll with a set temperature of 40° C. and then taken up onto a take-up roll. This film was continuously stretched to three times its original length in the MD direction using a roll longitudinal stretching machine at 60° C. Subsequently, the film was further stretched continuously in the width (TD) direction using a transverse stretching machine (clip tenter) at a stretch temperature of 70° C. and a stretch ratio of 5. The film subjected to biaxial stretching was then cooled to 50° C., and the ends of the width of the cooled film were cut of to obtain a biaxially stretched film having a width of 1200 mm and a thickness of 30 m. The above processes were carried out successively.

The value of (Ma÷10⁴)×Wb was calculated for the above resin blend. The calculated value is shown in Table 1. The film was inspected after the MD-direction stretching and after the TD-direction stretching to evaluate film stretchability. The resulting stretched film was evaluated for printability and haze. The evaluation results are shown in Table 1.

### Examples 2 to 7

Biaxially stretched films were obtained in the same manner as that of Example 1, except that the formulation was changed as shown in Table 1. The evaluation results are shown in Table 1.

### Comparative Examples 1 to 10

Biaxially stretched films were obtained in the same manner as that of Example 1, except that the formulation was changed as shown in Table 2. The evaluation results are shown in Table 2. In Comparative Example 6, the film broke during stretching in the MD direction and a stretched film was not obtained; therefore, printability and haze were not evaluated.

TABLE 1

| | | | | Ex. | Ex. | Ex. | Ex. | Ex. | Ex. | Ex. |
|---|---|---|---|---|---|---|---|---|---|---|
| | | | Unit | 1 | 2 | 3 | 4 | 5 | 6 | 7 |
| Formu- | P3HA (A) | (A-1) PHBH-1 (HH: 6 mol Mw 60 × 10⁴) | wt % | 31 | 46 | 31 | 46 | 31 | 54 | 0 |
| lation | | (A-2) PHBH-2 (HH: 6 mol Mw 40 × 10⁴) | wt % | 0 | 0 | 0 | 0 | 0 | 0 | 31 |
| | | (A-3) PHB (HH: 0 mol Mw 35 × 10⁴) | wt % | 5 | 8 | 5 | 8 | 5 | 9 | 5 |
| | | (A-4) PHB (HH: 0 mol Mw 60 × 10⁴) | wt % | 4 | 6 | 4 | 6 | 4 | 6 | 4 |
| | PLA (B) | (B-1) PLA: Wb | wt % | 60 | 40 | 60 | 40 | 60 | 30 | 60 |
| | Proportion of resin component | | wt % | 99.8 | 99.7 | 100 | 100 | 99.88 | 99.65 | 100 |
| | Nucleating agent | (C-1) Talc | parts by | 0 | 0 | 0 | 0 | 0 | 0 | 0 |
| | | | weight*¹ | | | | | | | |
| | | (C-2) Behenamide | parts by | 0.5 | 0.5 | 0 | 0 | 0.3 | 0.5 | 0 |
| | | | weight*¹ | | | | | | | |
| | | (C-3) Pentaerythritol | parts by | 0 | 0 | 0 | 0 | 0 | 0 | 0 |
| | | | weight*¹ | | | | | | | |
| | | (C-2) + (C-3) | parts by | 0.2 | 0.3 | 0 | 0 | 0.12 | 0.35 | 0 |
| | | | weight*² | | | | | | | |
| | Molecular weight | Weight-average molecular | Mw | 55 | 55 | 55 | 55 | 55 | 55 | 39 |
| | | weight Ma of total (A) | | | | | | | | |
| | | Weight-average molecular | Mw | 25 | 25 | 25 | 25 | 25 | 25 | 25 |
| | | weight of (B) | | | | | | | | |
| | | Weight-average molecular | Mw | 40 | 40 | 40 | 40 | 40 | 40 | 32 |
| | | weight Mab of total of | | | | | | | | |
| | | (A) and (B) | | | | | | | | |
| | Inequality (I) | (Ma ÷ 10⁴) × Wb | — | 3277 | 2185 | 3277 | 2185 | 3277 | 1639 | 2350 |
| Evaluation | Film moldability | T-die film molding speed | m/min | 18.5 | 18.5 | 18.5 | 17 | 17 | 17 | 18.5 |
| results | Film stretchability | MD stretching to 3 times @60-70° C. | — | Good | Good | Good | Good | Good | Good | Good |
| | | TD stretching to 5 times @70-80° C. | — | Good | Good | Good | Good | Good | Good | Good |
| | Printability | Ink adhesion | — | Good | Good | Good | Good | Good | Good | Good |
| | Haze | Total haze of film | % | 3 | 8 | 6 | 6 | 4 | 6 | 9 |

*¹Parts by weight per 100 parts by weight of (A)
*²Parts by weight per 100 parts by weight of total amount of (A) and (B)

TABLE 2

| | | | | Comp. | Comp. | Comp. | Comp. | Comp. |
|---|---|---|---|---|---|---|---|---|
| | | | Unit | 1 | 2 | 3 | 4 | 5 |
| Formulation | P3HA (A) | (A-1) PHBH-1 (HH: 6 mol Mw 60 × 10⁴) | wt % | 0 | 0 | 0 | 31 | 31 |
| | | (A-2) PHBH-2 (HH: 6 mol Mw 40 × 10⁴) | wt % | 46 | 46 | 31 | 0 | 0 |
| | | (A-3) PHB (HH: 0 mol Mw 35 × 10⁴) | wt % | 8 | 8 | 5 | 5 | 5 |
| | | (A-4) PHB (HH: 0 mol Mw 60 × 10⁴) | wt % | 6 | 6 | 4 | 4 | 4 |
| | PLA (B) | (B-1) PLA: Wb | wt % | 40 | 40 | 60 | 60 | 60 |
| | Proportion of resin component | | wt % | 100 | 98.8 | 99.2 | 99.2 | 99.2 |
| | Nucleating agent | (C-1) Talc | parts by weight*¹ | 0 | 2 | 2 | 2 | 2 |
| | | (C-2) Behenamide | parts by weight*¹ | 0 | 0 | 0 | 0 | 0 |
| | | (C-3) Pentaerythritol | parts by weight*¹ | 0 | 0 | 0 | 0 | 0 |
| | | (C-2) + (C-3) | parts by weight*² | 0 | 0 | 0 | 0 | 0 |
| | Molecular weight | Weight-average molecular | Mw | 39 | 39 | 39 | 55 | 55 |
| | | weight Ma of total (A) | | | | | | |
| | | Weight-average molecular | Mw | 25 | 25 | 25 | 25 | 25 |
| | | weight of (B) | | | | | | |
| | | Weight-average molecular | Mw | 32 | 32 | 32 | 40 | 40 |
| | | weight Mab of total of | | | | | | |
| | | (A) and (B) | | | | | | |
| | Inequality (I) | (Ma ÷ 10⁴) × Wb | — | 1566 | 1566 | 2350 | 3277 | 3277 |
| Evaluation | Film moldability | T-die film molding speed | m/min | 18.5 | 18.5 | 18.5 | 18.5 | 18.5 |
| results | Film stretchability | MD stretching to 3 times @60-70° C. | — | Good | Good | Good | Good | Good |
| | | TD stretching to 5 times @70-80° C. | — | Good | Good | Good | Good | Good |
| | Printability | Ink adhesion | — | Good | Good | Good | Good | Good |
| | Haze | Total haze of film | % | 40 | 60 | 20 | 15 | 60 |

| | | | Comp. | Comp. | Comp. | Comp. | Comp. |
|---|---|---|---|---|---|---|---|
| | | | 6 | 7 | 8 | 9 | 10 |
| Formulation | P3HA (A) | (A-1) PHBH-1 (HH: 6 mol Mw 60 × 10⁴) | 62 | 31 | 46 | 60 | 40 |
| | | (A-2) PHBH-2 (HH: 6 mol Mw 40 × 10⁴) | 0 | 0 | 0 | 0 | 0 |
| | | (A-3) PHB (HH: 0 mol Mw 35 × 10⁴) | 11 | 5 | 8 | 0 | 0 |
| | | (A-4) PHB (HH: 0 mol Mw 60 × 10⁴) | 7 | 4 | 6 | 0 | 0 |
| | PLA (B) | (B-1) PLA: Wb | 20 | 60 | 40 | 40 | 60 |
| | Proportion of resin component | | 99.6 | 99.6 | 99.4 | 99.1 | 100 |
| | Nucleating agent | (C-1) Talc | 0 | 0 | 0 | 0 | 0 |
| | | (C-2) Behenamide | 0.5 | 1 | 1 | 0.5 | 0 |
| | | (C-3) Pentaerythritol | 0 | 0 | 0 | 1 | 0 |
| | | (C-2) + (C-3) | 0.4 | 0.4 | 0.6 | 0.9 | 0 |
| | Molecular weight | Weight-average molecular | 55 | 55 | 55 | 60 | 60 |
| | | weight Ma of total (A) | | | | | |
| | | Weight-average molecular | 25 | 25 | 25 | 25 | 25 |
| | | weight of (B) | | | | | |
| | | Weight-average molecular | 40 | 40 | 40 | 43 | 43 |
| | | weight Mab of total of | | | | | |
| | | (A) and (B) | | | | | |
| | Inequality (I) | (Ma ÷ 10⁴) × Wb | 1092 | 3277 | 2185 | 2400 | 3600 |
| Evaluation | Film moldability | T-die film molding speed | 5 | 18.5 | 18.5 | 15 | 15 |
| results | Film stretchability | MD stretching to 3 times @60-70° C. | Poor | Good | Good | Good | Good |
| | | TD stretching to 5 times @70-80° C. | — | Good | Good | Good | Good |
| | Printability | Ink adhesion | | Average | Poor | Poor | Good |
| | Haze | Total haze of film | | 3 | 3 | 8 | 3 |

*¹Parts by weight per 100 parts by weight of (A)
*²Parts by weight per 100 parts by weight of total amount of (A) and (B)

Table 1 indicates that in Examples 1 to 7, the film molding speed reached 17 m/min or higher, and the films were produced with good productivity. In addition, the films were successfully stretched at high stretch ratios in both the MD and TD directions without uneven stretching. The resulting stretched films showed good printability and exhibited low haze values of 10% or less.

Table 2 shows that the haze values were high in Comparative Examples 1 to 5. In Comparative Example 6, both film productivity and stretchability were extremely poor, and no stretched film was obtained due to film breakage during stretching. In Comparative Examples 7 to 9, printability on the stretched films was poor. In Comparative Examples 9 and 10, film productivity was unsatisfactory.

In Comparative Examples 1, 2, and 6, the value of (Ma÷10⁴)×Wb was less than 1600. In Comparative Examples 2 to 9, the proportion of the resin component in the film was 99.6 wt % or less. In Comparative Examples 9 and 10, the poly(3-hydroxybutyrate) resin (A2) was not contained.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A stretched film comprising a resin component, wherein:
the resin component comprises a poly(3-hydroxyalkanoate) resin (A) and a polylactic acid resin (B),
the poly(3-hydroxyalkanoate) resin (A) comprises a copolymer (A1) of 3-hydroxybutyrate units and other hydroxyalkanoate units, and a poly(3-hydroxybutyrate) resin (A2),
a proportion of the resin component in the stretched film is more than 99.6 wt %, and
the resin component satisfies the following inequality (I):
$$inequality ( I ) : ( Ma \div {10}^{4} ) \times Wb ≧ 1600 ,$$
wherein Ma is a weight-average molecular weight of a totality of the poly(3-hydroxyalkanoate) resin (A), and Wb is a percentage weight proportion (wt %) of the polylactic acid resin (B) based on a total amount of the poly(3-hydroxyalkanoate) resin (A) and the polylactic acid resin (B).

2. The stretched film according to claim 1, further comprising an organic nucleating agent.

3. The stretched film according to claim 2, wherein the organic nucleating agent is at least one selected from the group consisting of fatty acid amides and sugar alcohols.

4. The stretched film according to claim 1, wherein the percentage weight proportion Wb of the polylactic acid resin (B) based on the total amount of the poly(3-hydroxyalkanoate) resin (A) and the polylactic acid resin (B) is from 30 wt % to 60 wt %.

5. The stretched film according to claim 1, wherein the weight-average molecular weight Ma of the total poly(3-hydroxyalkanoate) resin (A) is from 30×10⁴ to 70×10⁴.

6. The stretched film according to claim 1, wherein a weight-average molecular weight Mab of a totality of the poly(3-hydroxyalkanoate) resin (A) and the polylactic acid resin (B) is from 25×10⁴ to 50×10⁴.

7. The stretched film according to claim 1, wherein a proportion of the poly(3-hydroxybutyrate) resin (A2) in the poly(3-hydroxyalkanoate) resin (A) is from 10 wt % to 30 wt %.

8. The stretched film according to claim 1, wherein the copolymer (A1) comprises a copolymer (A1-1) comprising 3-hydroxybutyrate units and other hydroxyalkanoate units, and in which a proportion of the 3-hydroxybutyrate units is from 76 mol % to 99 mol %.

9. The stretched film according to claim 1, wherein a total haze of the stretched film is 10% or less.

10. A laminate comprising:
a core layer; and
a surface layer comprising the stretched film according to claim 1 and located on at least one side of the core layer.

11. The laminate according to claim 10, wherein the surface layer is located on both sides of the core layer.

12. The laminate according to claim 10, further comprising a printed layer located on at least a portion of a surface of the surface layer.

13. The laminate according to claim 10, wherein the core layer comprises a poly(3-hydroxyalkanoate) resin (C).
